(19) United States
(12) Patent Application Publication
(10) Pub. No.: US 2024/0265312 A1
(43) Pub. Date: Aug. 8, 2024

(54) AUTOMATICALLY DETERMINING RESOURCE SUPPORT PARAMETERS USING ARTIFICIAL INTELLIGENCE TECHNIQUES

(71) Applicant: Dell Products. L.P., Round Rock, TX (US)

(72) Inventors: David J. Linsey, Marietta, GA (US); Bijan Kumar Mohanty, Austin, TX (US); Tiffany E. Wilson, Cedar Park, TX (US)

(21) Appl. No.: 18/107,275

(22) Filed: Feb. 8, 2023

(51) Int. Cl. G06N 20/20; G06N 3/02

(52) U.S. Cl. CPC G06N 20/20; G06N 3/02

(57) ABSTRACT

Methods, apparatus, and processor-readable storage media for automatically determining resource support parameters using artificial intelligence techniques are provided herein. An example computer-implemented method includes obtaining input data comprising data pertaining to at least one resource and data pertaining to one or more users associated with the at least one resource; predicting one or more resource support parameters for the at least one resource and the one or more users associated therewith by processing at least a portion of the input data using one or more artificial intelligence techniques; determining one or more resource support-related data allocations, across one or more systems, for the at least one resource and the one or more users associated therewith based on the one or more predicted resource support parameters; and performing one or more automated actions based on the one or more resource support-related data allocations.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The field relates generally to information processing systems, and more particularly to techniques for managing resources in such systems.

### BACKGROUND

With respect to providing support resources in connection with various devices, systems, and/or components related thereto, different users will have different demands and different levels of usage of the support resources. However, conventional resource management approaches commonly rely on static parameters across multiple users, leading to the wasting and/or inefficient use of resources for users and support providers.

### SUMMARY

Illustrative embodiments of the disclosure provide techniques for automatically determining resource support parameters using artificial intelligence techniques.

An exemplary computer-implemented method includes obtaining input data comprising data pertaining to at least one resource and data pertaining to one or more users associated with the at least one resource, and predicting one or more resource support parameters for the at least one resource and the one or more users associated therewith by processing at least a portion of the input data using one or more artificial intelligence techniques. The method also includes determining one or more resource support-related data allocations, across one or more systems, for the at least one resource and the one or more users associated therewith based at least in part on the one or more predicted resource support parameters. Further, the method additionally includes performing one or more automated actions based at least in part on the one or more resource support-related data allocations.

Illustrative embodiments can provide significant advantages relative to conventional resource management approaches. For example, problems associated with the wasting and/or inefficient use of resources are overcome in one or more embodiments through automatically determining and implementing one or more resource support parameters using artificial intelligence techniques.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for automatically determining resource support parameters using artificial intelligence techniques in an illustrative embodiment.

FIG. 2 shows example architecture in an illustrative embodiment.

FIG. 3 shows example architecture for a resource support parameter prediction engine in an illustrative embodiment.

FIG. 4 shows example pseudocode for implementing at least a portion of a resource support parameter prediction engine in an illustrative embodiment.

FIG. 5 shows example pseudocode for implementing at least a portion of a resource support parameter prediction engine in an illustrative embodiment.

FIG. 6 shows example pseudocode for implementing at least a portion of a resource support parameter prediction engine in an illustrative embodiment.

FIG. 7 shows example pseudocode for implementing at least a portion of a resource support parameter prediction engine in an illustrative embodiment.

FIG. 8 shows example pseudocode for implementing at least a portion of a resource support parameter prediction engine in an illustrative embodiment.

FIG. 9 shows example pseudocode for implementing at least a portion of a resource support parameter prediction engine in an illustrative embodiment.

FIG. 10 shows example pseudocode for implementing at least a portion of a resource support parameter prediction engine in an illustrative embodiment.

FIG. 11 shows example pseudocode for implementing at least a portion of a resource support parameter prediction engine in an illustrative embodiment.

FIG. 12 is a flow diagram of a process for automatically determining resource support parameters using artificial intelligence techniques in an illustrative embodiment.

FIGS. 13 and 14 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

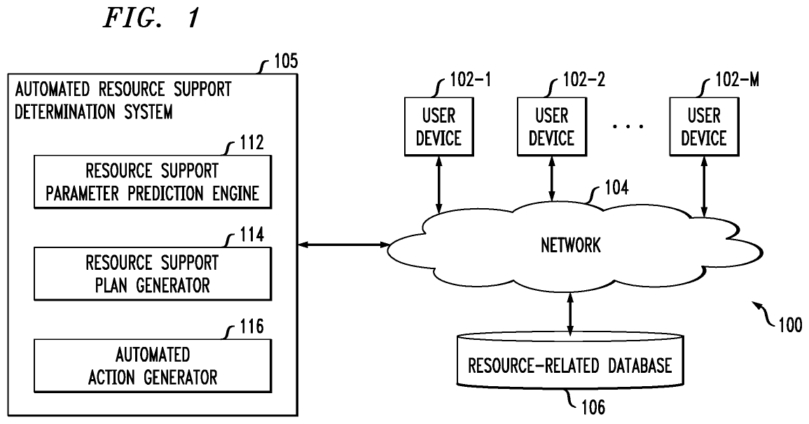

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated resource support determination system 105.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, automated resource support determination system 105 can have an associated resource-related database 106 configured to store data pertaining to one or more resource utilization metrics, resource support burden information, user-related information associated with one or more resources, etc.

The resource-related database 106 in the present embodiment is implemented using one or more storage systems associated with automated resource support determination system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with automated resource support determination system 105 are one or more input-output devices, which illustratively comprise keyboards, displays or other types of input-output devices in any combination. Such input-output devices can be used, for example, to support one or more user interfaces to automated resource support determination system 105, as well as to support communication between automated resource support determination system 105 and other related systems and devices not explicitly shown.

Additionally, automated resource support determination system 105 in the FIG. 1 embodiment is assumed to be implemented using at least one processing device. Each such processing device generally comprises at least one processor and an associated memory, and implements one or more functional modules for controlling certain features of automated resource support determination system 105.

More particularly, automated resource support determination system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows automated resource support determination system 105 to communicate over the network 104 with the user devices 102, and illustratively comprises one or more conventional transceivers.

The automated resource support determination system 105 further comprises resource support parameter prediction engine 112, resource support plan generator 114, and automated action generator 116.

It is to be appreciated that this particular arrangement of elements 112, 114 and 116 illustrated in the automated resource support determination system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for automatically determining resource support parameters using artificial intelligence techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, automated resource support determination system 105 and resource-related database 106 can be on and/or part of the same processing platform.

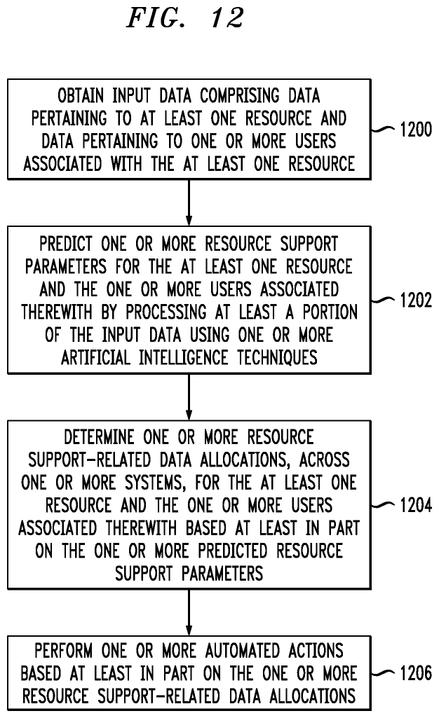

An exemplary process utilizing elements 112, 114 and 116 of an example automated resource support determination system 105 in computer network 100 will be described in more detail with reference to the flow diagram of FIG. 12.

Accordingly, at least one embodiment includes artificial intelligent-based support resource management (e.g., support pricing) based at least in part on anticipated usage, predicted burden costs, and expected margin. Such an embodiment includes leveraging at least one artificial intelligence model implemented to predict user skill levels, and thus infer how much support the corresponding user(s) may demand from the support provider(s). Such predicted intelligence can then be fed into and/or processed by one or more pricing models to provide improved and/or more accurate pricing to users. Additionally, as used herein, a burden refers to a cost associated with supporting a resource for a user, and a given burden can vary across users and resources based on a variety of factors (e.g., utilization data).

Also, one or more embodiments include determining support costs (burdens) of resources (e.g., hardware devices) by predicting future events including, for example, resource-related communications, resource-related remedy actions and/or categories (e.g., parts only, labor only, parts and labor, etc.), and resource-related lifespan information by factoring a multitude of dynamic user-specific variables learned from historical data. Such historical data can include user-specific utilization metrics as captured from resource information such as up-time, aging, etc.

At least one embodiment also includes conducting one or more data engineering steps such as, for example, extracting one or more features (e.g., aging information derived from manufacturing date, the cost of support burden from various communications and break-fix events, the expected support margin for each resource, etc.) from historical data. As used herein, a break-fix event includes a situation wherein a product (e.g., a computer) is physically broken in some capacity and needs to be fixed in the field (e.g., at the user's location). These events may be “parts only” (e.g., the user is shipped a new hard drive, and the user carries out the fix-related actions), “parts and labor” (e.g., the user is shipped a new hard drive and a technician is scheduled to come to the user location and install the new hard drive), or “labor only” (e.g., a technician is only needed to perform on-site work, but no expected parts are required). For example, in one or more embodiments, support burden costs and expected margins can be used as target variables (dependent variables) in generating predictions. Such influencing variables can be extracted and filtered to create a dataset that can be stored in at least one data repository for future training and analysis. For example, such a dataset can be used to train one or more shallow learning techniques and one or more deep learning neural network-based regressors for multi-output prediction.

In at least one embodiment, once the burden cost and expected margin are predicted for a given resource, these data are fed into at least one pricing engine for calculating a customized cost of warranty for that resource. The expected margin for a given type or category of resource can vary based on a variety of factors including user identifying information, type of user, resource context-related information, etc. In such an embodiment, expected margin is a target variable along with the calculated burden cost of the resource based at least in part on the support interactions associated with the resource. Additionally, both the burden cost and the expected margin can be processed by at least one pricing engine to calculate a customized warranty price for a specific user and a specific resource.

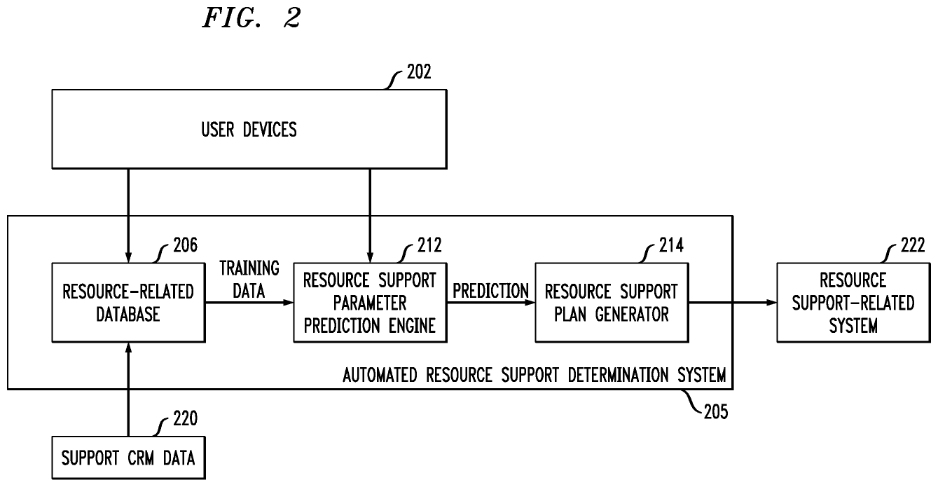

FIG. 2 shows example architecture in an illustrative embodiment. By way of illustration, FIG. 2 depicts an embodiment wherein automated resource support determination system 205 includes resource-related database 206 (e.g., including resource utilization data, support burden data, etc.), resource support parameter (e.g., support burden) prediction engine 212, and resource support plan generator 214 (which can include, e.g., a smart warranty pricing engine). Specifically, FIG. 2 depicts user devices 202 providing device data (e.g., error logs, system alerts, on/off statistics, install, move, add, change (IMAC) data, etc.) to resource-related database 206, which stores such data among other historical resource utilization data and support-related metrics from a variety of resources. As also depicted in FIG. 2, other information including, for example, incident data, communication data, defect-related data, resource component information, etc. can be provided to resource-related database 206 from at least one support customer relationship management (CRM) data source 220. Additionally, at least a portion of the data stored in resource-related database 206 can be used to train resource support parameter prediction engine 212.

In at least one embodiment, and in connection with storing such data in resource-related database 206, the data can be filtered and/or otherwise preprocessed to reduce noise and unnecessary attributes before being stored. Data engineering and/or data analysis can be carried out to understand and/or determine one or more features and the data that will influence the target variable(s) (e.g., the total burden cost and the expected margin). In one or more embodiments, expected margin data can be determined using historical data, while the total burden cost can be calculated and populated as part of feature engineering from, for example, the number of user communications from one or more channels as well as support tickets and dispatches associated with the user. By way of illustration, example data elements such as, for instance, user-related data, enterprise unit identifying information, product information, user location, manufacturing data, utilization information, number of incidents, email information, chat information, voice mail information, parts information, labor information, margin information, etc., can be filtered and stored in resource-related database 206 and used for training resource support parameter prediction engine 212.

After feature engineering, and as further detailed herein, one or more embodiments can include computing and/or determining aging-related information associated with the given resource and target variables (e.g., total burden cost) from data provided by user devices 202 using the trained resource support parameter prediction engine 212.

Accordingly, in at least one embodiment, resource support parameter prediction engine 212 is implemented to predict the total support burden cost, as well as the weighted average cost, for at least one resource in connection with at least one particular user by processing various features of resource utilization and support data. As further detailed herein, and as depicted in FIG. 2, the output of resource support parameter prediction engine 212 (e.g., a support burden prediction) is used as at least partial input to resource support plan generator 214, which determines at least one support plan (e.g., computing a customized pricing for the resource warranty and/or extended warranty) for the at least one resource in connection with the at least one particular user. Additionally, as also depicted in FIG. 2, the resource support plan generated by resource support plan generator 214 can be output to one or more systems including, for example, resource support-related system 222 (which can include, for instance, a system associated with one or more enterprise warranty teams).

Resource support parameter prediction engine 212, as detailed herein, can leverage one or more supervised learning mechanisms and train at least one model with historical data related to support interactions from multiple channels (e.g., email, chat, voice, etc.), incidents, defects, and/or various features including resource utilization and support-specific metrics (e.g., cases, dispatches, etc.) associated with one or more resources. During the training, in one or more embodiments, such features are fed into and/or processed by the model as independent variables, and the total burden cost as well as the expected margin are identified as the dependent/target variable(s). Subsequently, using data pertaining to at least one given resource and at least one particular user, the trained model of resource support parameter prediction engine 212 can predict the total support burden associated therewith, as well as the expected margin associated therewith.

As further detailed herein, one or more embodiments include predicting support burden cost(s) as well as expected margin(s). Both of these targeted predictions represent quantitative data and can be used for regressions. For example, such an embodiment can include implementing a multi-output regression which can predict more than one item at a time by learning from one set of data (e.g., features). In carrying out such actions, at least one embodiment can include using either shallow learning techniques or deep learning techniques.

By way of example, such an embodiment can include using shallow learning algorithms including a gradient boosting regressor as well as a random forest regressor (as further detailed herein). Both of these algorithms fall under an ensemble decision tree category, but while gradient boosting uses a boosting approach (i.e., sequentially pass data through one tree to another tree and correct errors in a corresponding prediction), random forest takes a parallel approach. Also, in one or more embodiments, the same learning data can be passed to and/or processed by both algorithms.

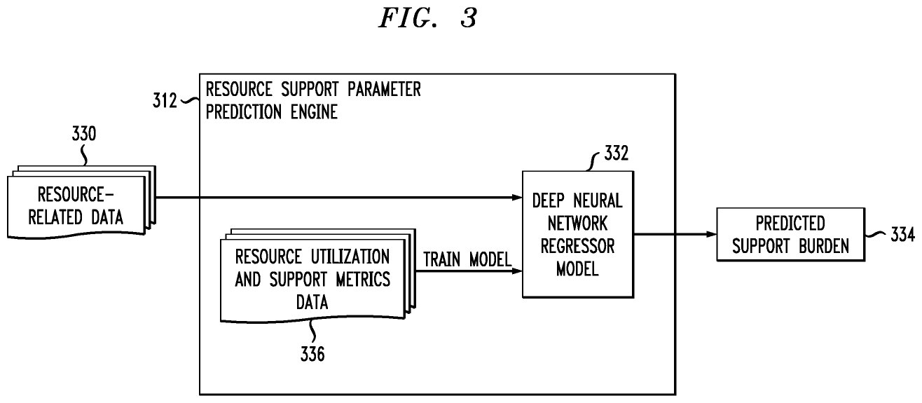

FIG. 3 shows example architecture for a resource support parameter prediction engine in an illustrative embodiment. By way of illustration, FIG. 3 depicts resource support parameter prediction engine 312, which includes deep neural network regressor model 332. More specifically, resource support parameter prediction engine 312 also includes resource utilization and support metrics data 336, which is used to train deep neural network regressor model 332. Further, resource-related data 330 is processed using the trained deep neural network regressor model 332 to generate at least one support burden prediction 334 associated with at least one resource and at least one corresponding user associated with the processed resource-related data 330. By way of example, in at least one embodiment, a multi-layer deep neural network can be built with one input layer, two parallel networks of hidden layers and an output layer to predict two different items.

As further detailed herein, the resource support parameter prediction engine can be built using SciKitLearn libraries with Python programming language. Example pseudocode to implement multi-class regression using a shallow learning approach (e.g., ensemble bagging and boosting) to predict burden costs and expected margins is depicted in FIG. 4 through FIG. 11.

FIG. 4 shows example pseudocode for implementing at least a portion of a resource support parameter prediction engine in an illustrative embodiment. In this embodiment, example pseudocode 400 is executed by or under the control of at least one processing system and/or device. For example, the example pseudocode 400 may be viewed as comprising a portion of a software implementation of at least part of automated resource support determination system 105 of the FIG. 1 embodiment.

The example pseudocode 400 illustrates importing the necessary libraries including SciKitLearn, Pandas, Numpy, Matplotlib, and Seaborn.

It is to be appreciated that this particular example pseudocode shows just one example implementation of importing libraries in connection with at least a portion of a resource support parameter prediction engine, and alternative implementations can be used in other embodiments.

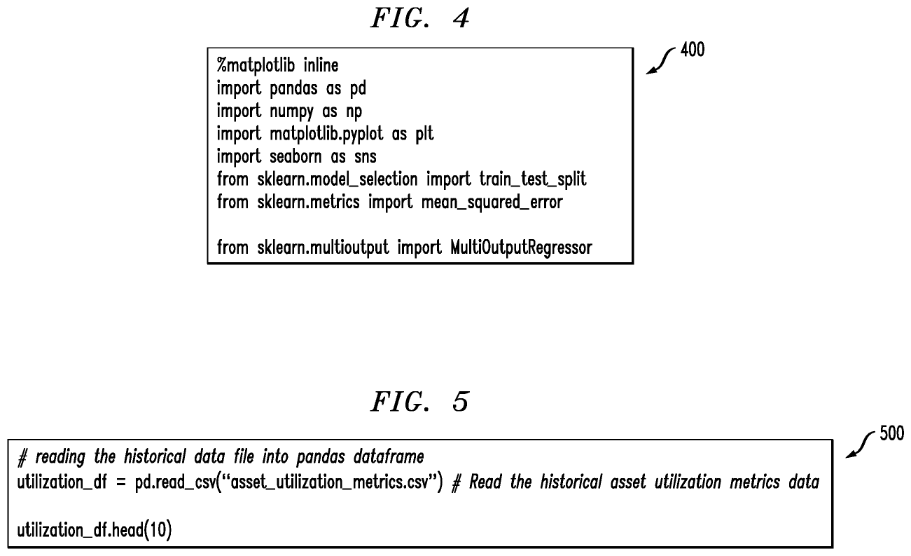

FIG. 5 shows example pseudocode for implementing at least a portion of a resource support parameter prediction engine in an illustrative embodiment. In this embodiment, example pseudocode 500 is executed by or under the control of at least one processing system and/or device. For example, the example pseudocode 500 may be viewed as comprising a portion of a software implementation of at least part of automated resource support determination system 105 of the FIG. 1 embodiment.

The example pseudocode 500 illustrates reading a historical asset utilization data file to create a training data frame. Specifically, the data are created as a comma-separated values (CSV) file and the data are read to a Pandas data frame.

It is to be appreciated that this particular example pseudocode shows just one example implementation of reading historical asset utilization data in connection with at least a portion of a resource support parameter prediction engine, and alternative implementations can be used in other embodiments.

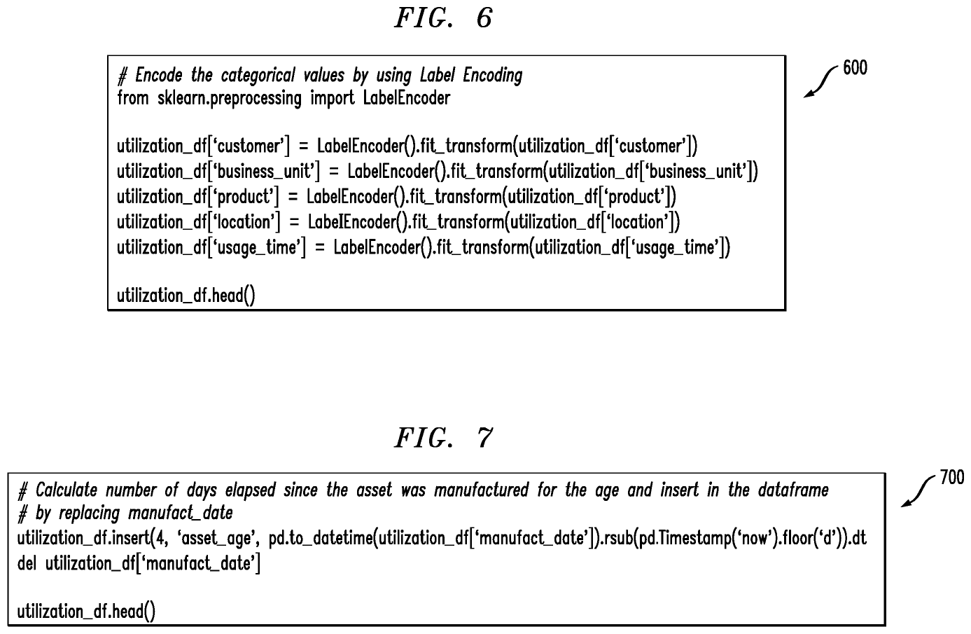

FIG. 6 shows example pseudocode for implementing at least a portion of a resource support parameter prediction engine in an illustrative embodiment. In this embodiment, example pseudocode 600 is executed by or under the control of at least one processing system and/or device. For example, the example pseudocode 600 may be viewed as comprising a portion of a software implementation of at least part of automated resource support determination system 105 of the FIG. 1 embodiment.

The example pseudocode 600 illustrates encoding categorical values, using LabelEncoder of a SciKitLearn library, to numerical values, rendering the values compatible with machine learning techniques (e.g., a resource support parameter prediction engine).

It is to be appreciated that this particular example pseudocode shows just one example implementation of encoding categorical values in connection with at least a portion of a resource support parameter prediction engine, and alternative implementations can be used in other embodiments.

FIG. 7 shows example pseudocode for implementing at least a portion of a resource support parameter prediction engine in an illustrative embodiment. In this embodiment, example pseudocode 700 is executed by or under the control of at least one processing system and/or device. For example, the example pseudocode 700 may be viewed as comprising a portion of a software implementation of at least part of automated resource support determination system 105 of the FIG. 1 embodiment.

The example pseudocode 700 illustrates performing a feature engineering step including computing the age of the device (e.g., the days elapsed) from the manufacturing date and replacing the manufacturing data in the data frame with the computed device age. Manufacturing dates of devices are important indicators of the ages of devices and can directly influence future support interactions, thus affecting the support burden costs of the devices.

It is to be appreciated that this particular example pseudocode shows just one example implementation of at least one feature engineering step in connection with at least a portion of a resource support parameter prediction engine, and alternative implementations can be used in other embodiments.

FIG. 8 shows example pseudocode for implementing at least a portion of a resource support parameter prediction engine in an illustrative embodiment. In this embodiment, example pseudocode 800 is executed by or under the control of at least one processing system and/or device. For example, the example pseudocode 800 may be viewed as comprising a portion of a software implementation of at least part of automated resource support determination system 105 of the FIG. 1 embodiment.

The example pseudocode 800 illustrates performing a feature engineering step to compute the support burden cost from interactions in multiple channels and insert the computed value into the data frame.

It is to be appreciated that this particular example pseudocode shows just one example implementation of at least one feature engineering step in connection with at least a portion of a resource support parameter prediction engine, and alternative implementations can be used in other embodiments.

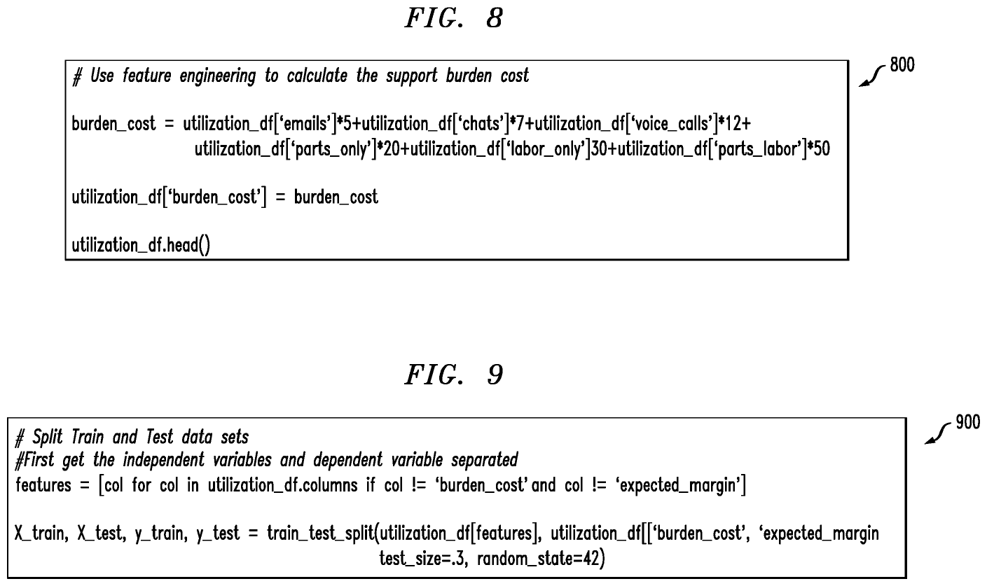

FIG. 9 shows example pseudocode for implementing at least a portion of a resource support parameter prediction engine in an illustrative embodiment. In this embodiment, example pseudocode 900 is executed by or under the control of at least one processing system and/or device. For example, the example pseudocode 900 may be viewed as comprising a portion of a software implementation of at least part of automated resource support determination system 105 of the FIG. 1 embodiment.

The example pseudocode 900 illustrates splitting the data into training and testing datasets using train_test_split function of a Sklearn library. The training dataset will be used for training the model, while the testing dataset will be used for testing and/or validating and computing the accuracy score of the model. In one or more embodiments, the training dataset can contain approximately 70% of the initial data while the testing dataset can contain approximately 30% of the initial data. Additionally, in at least one embodiment, the train_test_split function can also separate the dependent variables (X) and the independent/target variable (y).

It is to be appreciated that this particular example pseudocode shows just one example implementation of splitting data into training and testing sets in connection with at least a portion of a resource support parameter prediction engine, and alternative implementations can be used in other embodiments.

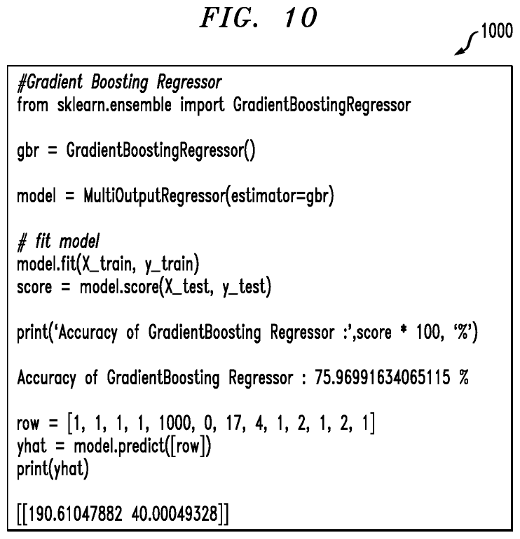

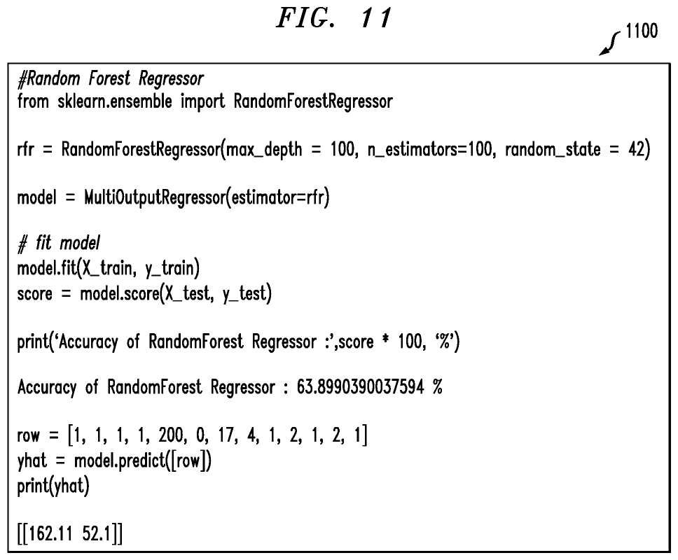

FIG. 10 shows example pseudocode for implementing at least a portion of a resource support parameter prediction engine in an illustrative embodiment. In this embodiment, example pseudocode 1000 is executed by or under the control of at least one processing system and/or device. For example, the example pseudocode 1000 may be viewed as comprising a portion of a software implementation of at least part of automated resource support determination system 105 of the FIG. 1 embodiment.

The example pseudocode 1000 illustrates using shallow learning regressor techniques for creating a multi-output regressor using both ensemble boosting (e.g., a gradient boosting regressor) as well as ensemble bagging (e.g., a random forest regressor). Similar to other ensemble algorithms (e.g., random forest), gradient boosting uses multiple decision tree classifiers and then uses the mode value of the output of the decision tree classifiers as the prediction. However, unlike random forest, which uses parallel execution of the decision trees, gradient boosting uses sequential execution. Accordingly, as depicted in FIG. 10, the gradient boosting regressor for a multi-output regressor is created and the accuracy score as well as predictions for burden cost and expected margin are computed.

It is to be appreciated that this particular example pseudocode shows just one example implementation of creating a multi-output regressor in connection with at least a portion of a resource support parameter prediction engine, and alternative implementations can be used in other embodiments.

FIG. 11 shows example pseudocode for implementing at least a portion of a resource support parameter prediction engine in an illustrative embodiment. In this embodiment, example pseudocode 1100 is executed by or under the control of at least one processing system and/or device. For example, the example pseudocode 1100 may be viewed as comprising a portion of a software implementation of at least part of automated resource support determination system 105 of the FIG. 1 embodiment.

The example pseudocode 1100 illustrates the same data as used in FIG. 10 being used to train a random forest multi-output regressor, wherein its score as well as predictions are depicted in FIG. 11.

As detailed herein, shallow learning techniques can be implemented when there is less data dimensions and less efforts are expected for training a model. As a shallow learning option in connection with one or more embodiments, an ensemble bagging technique with a random forest algorithm and a gradient boosting is utilized as a regressor approach for predicting both support burden cost(s) and expected margin(s).

A random forest algorithm provides efficiency and accuracy in connection with processing large volumes of data, and such an algorithm also uses bagging techniques (i.e., bootstrap aggregating techniques) to generate predictions. This can include using multiple regressors (e.g., multiple regressors used in parallel), each trained on different data samples and different features. Such an embodiment can include reducing variance and bias stemming from using a single classifier. Additionally, in such an embodiment, a final regression is achieved by aggregating the predictions that were made by the different regressors.

Similarly, a gradient boosting algorithm uses boosting techniques (i.e., combining multiple models into a single composite model) and falls under the same class of ensemble tree techniques as a random forest algorithm. Gradient boosting uses a sequential approach for traversing through decision trees, and uses gradient descent techniques to minimize the loss (e.g., the difference between the actual value and the predicted value). By passing sequentially, gradient boosting improves upon the loss and learns from the previous mistake(s), thereby providing more accurate predictions.

It is to be appreciated that this particular example pseudocode shows just one example implementation of training a multi-output regressor in connection with at least a portion of a resource support parameter prediction engine, and alternative implementations can be used in other embodiments.

Additionally, in one or more embodiments, hyperparameter tuning can be carried out in connection with the models, and a decision to select an optimal right algorithm can be made based at least in part on the accuracy score(s).

Referring again to FIG. 2, resource support plan generator 214 can generate one or more outputs which can aid and/or facilitate support-related systems in allocating support resources. For example, such an output can be provided to at least one system associated with a warranty team, which can use the output to allocate support resources (e.g., warranty services and prices) that are customized for a given user in connection with one or more particular resources (e.g., devices) based at least in part on expected resource utilization as well as the predicted support burden.

In one or more embodiments, resource support plan generator 214 processes predicted values (e.g., support burden cost(s) and expected margin(s)) generated by resource support parameter prediction engine 212 and generates at least one support plan, which can include, for example, computing a warranty price associated with the corresponding resource(s) and user(s). For example, in at least one embodiment, resource support plan generator 214 can perform such a computation using the following formula:

$$P = C / ( 1 - M )$$

wherein P represents the warranty price of the resource, C represents the predicted burden cost of the resource, and M represents the predicted margin associated with the resource.

By way merely of example and illustration, using predicted values generated by resource support parameter prediction engine 212 (e.g., determined via implementation of a gradient boosting regressor), resource support plan generator 214 can generate the warranty price of a given resource in connection with a given user as follows:

$$C = 190.6 \; 1047882$$

$$M = 40.00049 \; 328 \% = 0. 4000049 \; 328$$

$$P = \frac{190.61047882}{( 1 - 0.4000049328 )} = 317.69 ( rounded to two decimal places )$$

By way merely of further example and illustration, consider a use case which includes the following support cost breakdown:
Service Interaction: phone call; average time burden of 20 minutes; average cost=$12.
Service Interaction: email; average time burden of 5 minutes; average cost=$5.
Service Interaction: chat; average time burden of 8 minutes; average cost=$7.
Service Interaction: parts-only service; average time burden of 10 minutes; average cost=$20.
Service Interaction: parts and labor service; average time burden of 60 minutes; average cost=$50.

Additionally, in connection with this example use case, consider a support offer that includes the following: one year support term; price=$100; anticipated cost=$40; anticipated profit=$60; anticipated margin=60%.

Further, in connection with this example use case, consider the following users: User A, who is not technically savvy; and User B, who is technically savvy.

Based on the above-noted information and taking the one year support offer as an example, it is evident that a single parts and labor service interaction (e.g., a part is shipped out to a user and a field technician is dispatched to perform the repair and/or replacement at the user location) will consume more than the entire anticipated cost for the single year support offer. Should the user require two of these interactions (i.e., 2×$50=$100 cost), for example, then no profit will be made, and should the user require three or more such interactions, money will be lost.

However, if the user is more technically savvy and able to perform the repair and/or replacement themselves, this can change into a parts-only service event which is a 60% lower cost ($20) when compared to a parts and labor service. The parts-only service will only consume half of the anticipated $40 cost for the one year support offer, still leaving the profit whole and even room for one or more additional service interactions.

Referring again to User A and User B, assume that User A requires a single parts and labor service event in their one year, and User B requires a single parts-only service event in their one year. In aggregate, for User A and User B, the total price is $200 (i.e., 2×$100), the total anticipated cost is $80 (i.e., 2×$40), and the total anticipated profit is $120 (i.e., 2×$60). With one user (User A) requiring a parts and labor service and one user (User B) requiring a parts-only service, the total actual cost is $70 (i.e., $20+$50), and therefore, overall, the margin target is exceeded by hitting a 65% margin (i.e., 1−(70/200)). However, this was unbalanced from the perspective of the users, with User A accounting for 71% (i.e., $50/$70) of the total cost to the support service provider.

As such, in accordance with one or more embodiments, by implementing an artificial intelligence-based resource support parameter prediction engine and predicting, in advance, an anticipated support burden difference between the two users, such an embodiment can include generating and outputting to the two users, resource support plans (e.g., including pricing parameters) more in line with their anticipated demand (e.g., a price of $150 for User A and a price of $50 for User B). Such user-specific plans can therefore result in more accurate and efficient allocation of resources.

It is to be appreciated that some embodiments described herein utilize one or more artificial intelligence models. It is to be appreciated that the term “model,” as used herein, is intended to be broadly construed and may comprise, for example, a set of executable instructions for generating computer-implemented recommendations and/or predictions. For example, one or more of the models described herein may be trained to generate predictions based on resource utilization data, and such predictions can be used to initiate one or more automated actions (e.g., generating one or more resource support plans customized for one or more specific resources in association with one or more particular users).

FIG. 12 is a flow diagram of a process for automatically determining resource support parameters using artificial intelligence techniques in an illustrative embodiment. It is to be understood that this particular process is only an example, and additional or alternative processes can be carried out in other embodiments.

In this embodiment, the process includes steps 1200 through 1206. These steps are assumed to be performed by automated resource support determination system 105 utilizing elements 112, 114 and 116.

Step 1200 includes obtaining input data comprising data pertaining to at least one resource and data pertaining to one or more users associated with the at least one resource. In at least one embodiment, data pertaining to at least one resource can include resource-related lifespan information, one or more error logs, one or more system alerts, on/off statistics, install, move, add, change (IMAC) data, and/or resource component information. Also, data pertaining to one or more users associated with the at least one resource can include resource-related user communication data, data related to one or more resource-related remedy actions requested by the one or more users, user identifying information, and/or user location information.

Step 1202 includes predicting one or more resource support parameters for the at least one resource and the one or more users associated therewith by processing at least a portion of the input data using one or more artificial intelligence techniques. In one or more embodiments, processing at least a portion of the input data using one or more artificial intelligence techniques includes implementing at least one multi-output regression technique using one or more ensemble learning techniques. In such an embodiment, implementing at least one multi-output regression technique includes using one or more of at least one ensemble boosting technique (e.g., at least one gradient boosting regression technique) and at least one ensemble bagging technique (e.g., at least one random forest regression technique). Additionally or alternatively, processing at least a portion of the input data using one or more artificial intelligence techniques can include processing the at least a portion of the input data using at least one deep neural network regressor model.

In one or more embodiments, predicting one or more resource support parameters includes predicting one or more costs associated with providing resource support to the one or more users in connection with the at least one resource by processing at least a portion of the input data using one or more artificial intelligence techniques. Additionally or alternatively, predicting one or more resource support parameters can include predicting at least one expected margin associated with providing resource support to the one or more users in connection with the at least one resource by processing at least a portion of the input data using one or more artificial intelligence techniques.

Step 1204 includes determining one or more resource support-related data allocations, across one or more systems, for the at least one resource and the one or more users associated therewith based at least in part on the one or more predicted resource support parameters. In at least one embodiment, determining the one or more resource support-related data allocations includes generating at least one resource support plan, which can include determining, based at least in part on the one or more predicted resource support parameters, at least one customized price associated with providing resource support to the one or more users in connection with the at least one resource.

Step 1206 includes performing one or more automated actions based at least in part on the one or more resource support-related data allocations. In one or more embodiments, performing one or more automated actions includes automatically initiating at least a portion of the one or more resource support-related data allocations in connection with the one or more systems. Additionally or alternatively, performing one or more automated actions can include automatically training at least a portion of the one or more artificial intelligence techniques based at least in part feedback related to the one or more resource support-related data allocations.

Accordingly, the particular processing operations and other functionality described in conjunction with the flow diagram of FIG. 12 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically determine resource support parameters using artificial intelligence techniques. These and other embodiments can effectively overcome problems associated with the wasting and/or inefficient use of resources.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

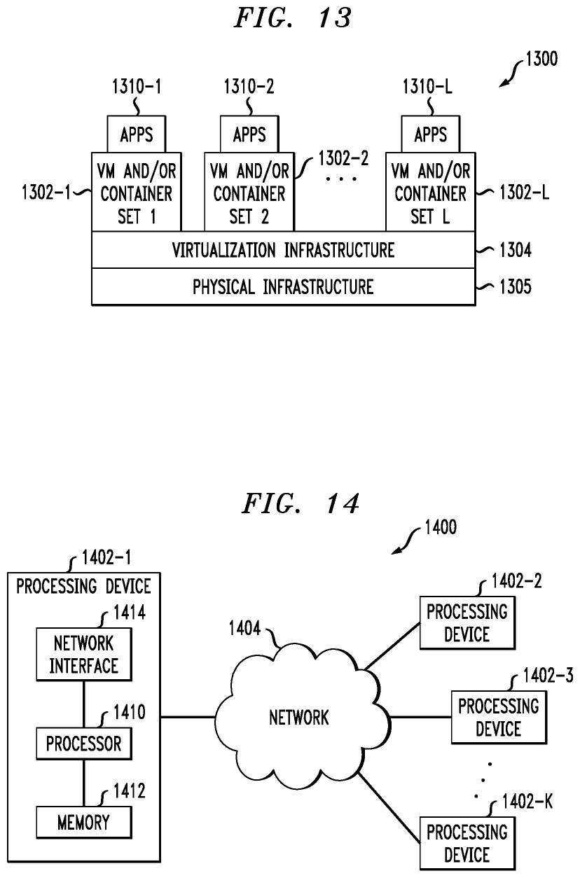

Illustrative embodiments of processing platforms will now be described in greater detail with reference to FIGS. 13 and 14. Although described in the context of system 100, these platforms may also be used to implement at least portions of other information processing systems in other embodiments.

FIG. 13 shows an example processing platform comprising cloud infrastructure 1300. The cloud infrastructure 1300 comprises a combination of physical and virtual processing resources that are utilized to implement at least a portion of the information processing system 100. The cloud infrastructure 1300 comprises multiple virtual machines (VMs) and/or container sets 1302-1, 1302-2, . . . 1302-L implemented using virtualization infrastructure 1304. The virtualization infrastructure 1304 runs on physical infrastructure 1305, and illustratively comprises one or more hypervisors and/or operating system level virtualization infrastructure. The operating system level virtualization infrastructure illustratively comprises kernel control groups of a Linux operating system or other type of operating system.

The cloud infrastructure 1300 further comprises sets of applications 1310-1, 1310-2, 1310-L running on respective ones of the VMs/container sets 1302-1, 1302-2, . . . 1302-L under the control of the virtualization infrastructure 1304. The VMs/container sets 1302 comprise respective VMs, respective sets of one or more containers, or respective sets of one or more containers running in VMs. In some implementations of the FIG. 13 embodiment, the VMs/container sets 1302 comprise respective VMs implemented using virtualization infrastructure 1304 that comprises at least one hypervisor.

A hypervisor platform may be used to implement a hypervisor within the virtualization infrastructure 1304, wherein the hypervisor platform has an associated virtual infrastructure management system. The underlying physical machines comprise one or more information processing platforms that include one or more storage systems.

In other implementations of the FIG. 13 embodiment, the VMs/container sets 1302 comprise respective containers implemented using virtualization infrastructure 1304 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 1300 shown in FIG. 13 may represent at least a portion of one processing platform. Another example of such a processing platform is processing platform 1400 shown in FIG. 14.

The processing platform 1400 in this embodiment comprises a portion of system 100 and includes a plurality of processing devices, denoted 1402-1, 1402-2, 1402-3, . . . 1402-K, which communicate with one another over a network 1404.

The network 1404 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1402-1 in the processing platform 1400 comprises a processor 1410 coupled to a memory 1412.

The processor 1410 comprises a microprocessor, a CPU, a GPU, a TPU, a microcontroller, an ASIC, a FPGA or other type of processing circuitry, as well as portions or combinations of such circuitry elements.

The memory 1412 comprises random access memory (RAM), read-only memory (ROM) or other types of memory, in any combination. The memory 1412 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1402-1 is network interface circuitry 1414, which is used to interface the processing device with the network 1404 and other system components, and may comprise conventional transceivers.

The other processing devices 1402 of the processing platform 1400 are assumed to be configured in a manner similar to that shown for processing device 1402-1 in the figure.

Again, the particular processing platform 1400 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining input data comprising data pertaining to at least one resource and data pertaining to one or more users associated with the at least one resource;
predicting one or more resource support parameters for the at least one resource and the one or more users associated therewith by processing at least a portion of the input data using one or more artificial intelligence techniques;
determining one or more resource support-related data allocations, across one or more systems, for the at least one resource and the one or more users associated therewith based at least in part on the one or more predicted resource support parameters; and
performing one or more automated actions based at least in part on the one or more resource support-related data allocations;
wherein the method is performed by at least one processing device comprising a processor coupled to a memory.

2. The computer-implemented method of claim 1, wherein processing at least a portion of the input data using one or more artificial intelligence techniques comprises implementing at least one multi-output regression technique using one or more ensemble learning techniques.

3. The computer-implemented method of claim 2, wherein implementing at least one multi-output regression technique comprises using one or more of at least one ensemble boosting technique and at least one ensemble bagging technique.

4. The computer-implemented method of claim 3, wherein using at least one ensemble boosting technique comprises using at least one gradient boosting regression technique.

5. The computer-implemented method of claim 3, wherein using at least one ensemble bagging technique comprises using at least one random forest regression technique.

6. The computer-implemented method of claim 1, wherein processing at least a portion of the input data using one or more artificial intelligence techniques comprises processing the at least a portion of the input data using at least one deep neural network regressor model.

7. The computer-implemented method of claim 1, wherein performing one or more automated actions comprises automatically initiating at least a portion of the one or more resource support-related data allocations in connection with the one or more systems.

8. The computer-implemented method of claim 1, wherein performing one or more automated actions comprises automatically training at least a portion of the one or more artificial intelligence techniques based at least in part feedback related to the one or more resource support-related data allocations.

9. The computer-implemented method of claim 1, wherein data pertaining to at least one resource comprises one or more of resource-related lifespan information, one or more error logs, one or more system alerts, on/off statistics, install, move, add, change (IMAC) data, and resource component information.

10. The computer-implemented method of claim 1, wherein data pertaining to one or more users associated with the at least one resource comprises one or more of resource-related user communication data, data related to one or more resource-related remedy actions requested by the one or more users, user identifying information, and user location information.

11. The computer-implemented method of claim 1, wherein predicting one or more resource support parameters comprises predicting one or more costs associated with providing resource support to the one or more users in connection with the at least one resource by processing at least a portion of the input data using one or more artificial intelligence techniques.

12. The computer-implemented method of claim 1, wherein predicting one or more resource support parameters comprises predicting at least one expected margin associated with providing resource support to the one or more users in connection with the at least one resource by processing at least a portion of the input data using one or more artificial intelligence techniques.

13. The computer-implemented method of claim 1, wherein determining the one or more resource support-related data allocations comprises determining, based at least in part on the one or more predicted resource support parameters, at least one customized price associated with providing resource support to the one or more users in connection with the at least one resource.

14. A non-transitory processor-readable storage medium having stored therein program code of one or more software programs, wherein the program code when executed by at least one processing device causes the at least one processing device:
to obtain input data comprising data pertaining to at least one resource and data pertaining to one or more users associated with the at least one resource;
to predict one or more resource support parameters for the at least one resource and the one or more users associated therewith by processing at least a portion of the input data using one or more artificial intelligence techniques;
to determine one or more resource support-related data allocations, across one or more systems, for the at least one resource and the one or more users associated therewith based at least in part on the one or more predicted resource support parameters; and
to perform one or more automated actions based at least in part on the one or more resource support-related data allocations.

15. The non-transitory processor-readable storage medium of claim 14, wherein processing at least a portion of the input data using one or more artificial intelligence techniques comprises implementing at least one multi-output regression technique using one or more ensemble learning techniques.

16. The non-transitory processor-readable storage medium of claim 15, wherein implementing at least one multi-output regression technique comprises using one or more of at least one ensemble boosting technique and at least one ensemble bagging technique.

17. The non-transitory processor-readable storage medium of claim 14, wherein processing at least a portion of the input data using one or more artificial intelligence techniques comprises processing the at least a portion of the input data using at least one deep neural network regressor model.

18. An apparatus comprising:
at least one processing device comprising a processor coupled to a memory;
the at least one processing device being configured:
to obtain input data comprising data pertaining to at least one resource and data pertaining to one or more users associated with the at least one resource;
to predict one or more resource support parameters for the at least one resource and the one or more users associated therewith by processing at least a portion of the input data using one or more artificial intelligence techniques;
to determine one or more resource support-related data allocations, across one or more systems, for the at least one resource and the one or more users associated therewith based at least in part on the one or more predicted resource support parameters; and
to perform one or more automated actions based at least in part on the one or more resource support-related data allocations.

19. The apparatus of claim 18, wherein processing at least a portion of the input data using one or more artificial intelligence techniques comprises implementing at least one multi-output regression technique using one or more ensemble learning techniques.

20. The apparatus of claim 19, wherein implementing at least one multi-output regression technique comprises using one or more of at least one ensemble boosting technique and at least one ensemble bagging technique.
